(19) United States
(12) Patent Application Publication
(10) Pub. No.: US 2017/0158901 A1
(43) Pub. Date: Jun. 8, 2017

(54) CELLULOSE ACETATE FILM FORMING COMPOSITIONS

(71) Applicant: CELANESE INTERNATIONAL CORPORATION, Irving, TX (US)

(72) Inventors: Wendy BISSET, Mountain View, CA (US); Xiaowei Zhang, Union, KY (US); Michael Combs, Pembroke, VA (US)

(21) Appl. No.: 15/370,580

(22) Filed: Dec. 6, 2016

Related U.S. Application Data
(60) Provisional application No. 62/264,283, filed on Dec. 7, 2015.
(60) Provisional application No. 62/278,681, filed on Jan. 14, 2016.
(60) Provisional application No. 62/344,681, filed on Jun. 2, 2016.

(51) Int. Cl. C09D 101/12

(52) U.S. Cl. CPC C09D 101/12

(57) ABSTRACT

A cellulose acetate lacquer composition comprises a film forming composition and a diluent. The film forming compositions comprise cellulose acetate, a plasticizer, a secondary film former, and at least one organic solvent. The lacquer compositions may be used in a method of providing a finish or protective cover on at least a portion of a substrate. The method comprises applying the lacquer composition to an inner or exterior surface of the substrate.

### CROSS-REFERENCE TO RELATED APPLICATIONS

This application is a non-provisional of U.S. Provisional Application Nos. 62/264,283, filed Dec. 7, 2015, 62/278,681, filed Jan. 14, 2016 and 62/344,681, filed Jun. 2, 2016, the entireties of which are incorporated herein by reference.

### FIELD OF THE INVENTION

The present invention relates generally to film forming compositions containing cellulose acetate. In particular, the present invention relates to film forming compositions that can be combined with further components to form lacquers. The film forming compositions comprise cellulose acetate, a plasticizer, a secondary film former, and at least one organic solvent.

### BACKGROUND OF THE INVENTION

The need exists for film forming compositions that are capable of adhering to a variety of substrate types, including, for example, treated wood, untreated wood, keratin, composite wood, and other film forming compositions. Lacquer is a clear or colored substrate finish that dries by solvent evaporation or a curing process that produces a hard, durable finish. In some instances, such as with respect to wood lacquers, it is desirable that the wood be able to maintain its natural beauty, such as when wood is stained to show the grain. It must not be readily apparent that a lacquer has been applied to the substrate. It is therefore important that the lacquer have a minimal amount of opaqueness or haziness. In other instances such as with respect to nail polish, it is desirable that the lacquer be able to take on decorative effects and suppress cracking or flaking. It is therefore less important that the lacquer have a minimal amount of opaqueness or haziness, and more important that the lacquer be combinable with dyes, pigments, thickening agents, stabilizers, and other compositions that provide a decorative look such as glitter. Regardless of the intended use of the lacquer, it is desirable that the lacquer remain adhered to the substrate, whether the substrate is natural, painted, or stained.

There are several beneficial characteristics to be achieved in a lacquer. The lacquer should be easily spreadable, and should spread without the lacquer breaking up as it is spread. A lacquer also most advantageously has a sufficiently long working time to allow the lacquer to be applied to the substrate before setting. It is also desirable to produce a lacquer that also has a relatively short setting time, so that the lacquer sets to a point where it can be sanded or otherwise finished in a relatively short period of time. In this regard, it is also beneficial to produce a lacquer that may be sanded without clogging the sand paper or other abrading media (that may reduce its efficacy). It is also beneficial to produce a lacquer that does not shrink or crack upon drying. Another beneficial characteristic in a lacquer is to have a relatively low post-drying density which bears a relation to the ability of the filler to resist cracking or shrinking upon drying.

Various lacquers are available in the art, and generally utilize waterborne technology or solvent-borne technology and dry by evaporation of the water or solvent. Although solvent-borne technologies form a surface skin more rapidly than waterborne technologies, the interior part of the product is still heavily filled with either a flammable solvent or water which prevents or restricts the product from complete internal setting/solidification. Upon drying, conventional lacquers are also subject to volume shrinkage due to the solvent or water that evaporates as the product sets. This effect may reduce the total strength of the finish. Hot melt adhesive technology provides rapid “through cure” as the product cools from a molten state to a fixed, room temperature state; however, such materials lack important lacquer properties such as ease of sandability and control over opaqueness or haziness. Therefore, there is an ongoing need for an effective lacquer product that does not suffer from these deficiencies.

The use of cellulose-containing compounds in lacquers is known in the art. As described in U.S. Pat. No. 2,092,229, a cellulose ester, specifically cellulose nitrate, also known as nitrocellulose, has been used in lacquer composition. Although nitrocellulose dries quickly and has other benefits, nitrocellulose also has a significant limitation because it will degrade and turn yellow over time. This is, of course, undesirable since it causes the lacquer to undergo color changes. Additionally, nitrocellulose is a highly flammable compound. Because of this flammability (and explosiveness), there is a commercial need for lacquer products with comparable performance but which do not use nitrocellulose or which use reduced amounts of nitrocellulose.

Cellulose-containing compounds containing cellulose acetate, as described in U.S. Pat. No. 1,958,707, include a basic coating of cellulose ester lacquer, an intermediate coating of a cellulose derivative, and an overcoating of cellulose acetate. However, these cellulose acetate compositions suffer from low adhesion on certain substrates, and a cloudy and non-homogeneous finish. Although cellulose acetate butyrate and cellulose acetate propionate are possible replacements, their costs make them less desirable for lacquers. Accordingly, the needs exist for cost-effective lacquer compositions that are capable of adhering to a variety of substrate types, including, for example, treated wood, untreated wood, keratin, composite wood, and other film forming compositions, but that do not have the flammability, color degradation, and opacity concerns of prior lacquer compositions.

### SUMMARY OF THE INVENTION

In one embodiment, the invention relates to a film forming composition, comprising: from 5 to 20 wt. % cellulose acetate, from 1 to 20 wt. % plasticizer, from 1 to 15 wt. % secondary film former, and from 50 to 92 wt. % of at least one organic solvent. The composition may comprise at least two organic solvents. The cellulose acetate may be present in an amount from 5 to 15 wt. % based on the total weight of the film forming composition. The weight ratio of plasticizer to cellulose acetate may range from 0.2:1 to 2:1 plasticizer to cellulose acetate. The composition may further comprise an additive, wherein the additive is a nitrogen-containing compound, an amine-containing compound, an amide-containing compound, or an imine-containing compound. The additive may be selected from the group consisting of phenylurea, urea, 3-aminopropyltriethoxysilane, polyethyleneimine, imidazole, aminopropyl triethyoxysilane, toluene sulfonamide, n-ethyl toluenesulfonamide, pyridines, and derivatives and combinations thereof, including 1-methyl imidazole. Lactams and caprolactams may also be used as additives. In some aspects, the secondary film former comprises an alkyd resin. In further aspects, the secondary film former comprises toluene sulfonamide aldehyde resin. In still other aspects, the secondary film former comprises toluene sulfonamide epoxy resin. In other aspects, the secondary film former comprises an acrylic. In further aspects, the secondary film former comprises a polyester. The secondary film former may comprise at least two secondary film formers. The at least one organic solvent may be selected from the group consisting of an ester, a ketone, an aldehyde, an acetal, an alcohol, and combinations thereof. In some aspects, the at least one organic solvent may be selected from the group consisting of acetone, n-butyl acetate, ethyl acetate, isopropanol, ethanol, methyl ethyl ketone, diacetone alcohol, isobutanol, ethyl lactate, methyl amyl ketone, methyl propyl ketone, dimethyl carbonate, dimethyl succinate, dimethyl glutarate, dimethyl adipate, and combinations thereof. The composition may further comprise and additive, and wherein the additive is an adhesion promoter, heat stabilizer, antioxidant, acid scavenger, acrylic, dye, pigment, aroma, optical brightener, flame retardant, agricultural chemical, bioactive compound, indicator, insecticide, UV stabilizer, or a mixture thereof. The composition may further comprise a cellulose ester in addition to cellulose acetate. The cellulose ester may be present in a weight percent less than the weight percent of the cellulose acetate. The cellulose ester may be selected from the group consisting of cellulose acetate propionate, cellulose acetate butyrate, cellulose nitrate, cellulose acetate phthalate, and combinations thereof.

In another embodiment, the present invention relates to a lacquer composition, comprising: a film forming composition comprising from 5 to 20 wt. % cellulose acetate; from 1 to 20 wt. % plasticizer; from 1 to 15 wt. % secondary film former, and from 50 to 92 wt. % of at least one organic solvent; and a diluent in an amount of from 35 to 65 wt. % based on the total weight of the lacquer composition. The film forming composition may be present from 10 to 35 wt. %, based on the total weight of the lacquer composition. The diluent may be an alcohol. In some aspects, the secondary film former comprises an alkyd resin. In further aspects, the secondary film former comprises toluene sulfonamide aldehyde resin. In still other aspects, the secondary film former comprises toluene sulfonamide epoxy resin. In other aspects, the secondary film former comprises an acrylic. In further aspects, the secondary film former comprises a polyester. In some aspects, the secondary film former comprises at least two secondary film formers. The film forming composition may further comprise a cellulose ester in addition to cellulose acetate, provided that the cellulose ester is present in a weight percent less than the weight percent of the cellulose acetate. The cellulose ester may be selected from the group consisting of cellulose nitrate, cellulose acetate propionate, cellulose acetate phthalate, cellulose acetate butyrate, cellulose acetate carboxylates, and combinations thereof. In some aspects, the lacquer composition may be a nail polish further comprising a pigment. In other aspects, the lacquer composition is a wood lacquer further comprising a dye or pigment.

In yet another embodiment, the present invention relates to a nail polish composition comprising: from 5 to 20 wt. % cellulose acetate, from 1 to 20 wt. % plasticizer, from 1 to 15 wt. % secondary film former, and from 50 to 92 wt. % of at least one organic solvent. The weight ratio of plasticizer to cellulose acetate may range from 0.2:1 to 2:1 plasticizer to cellulose acetate. The weight ratio of plasticizer to secondary film former may range from 1:3 to 3:1. The composition may comprise at least two organic solvents. The composition may further comprise a diluent. The diluent may be present from 10 to 30 wt. %. The composition may further comprise an adhesion promoter. The composition may further comprise an additive, including a pigment. The tack-free dry time of the composition may be at least 10% less than the same composition comprising cellulose nitrate and the scratch-free dry time may be at least 10% less than the same composition comprising cellulose nitrate.

In another embodiment, the present invention relates to a method of providing a finish or protective cover on at least a portion of a substrate, comprising: applying a lacquer composition to an inner or exterior surface of the substrate, wherein the lacquer composition comprises a diluent in an amount of from 35 to 65 wt. % based on the total weight of the lacquer composition and a film forming composition comprising from 5 to 20 wt. % cellulose acetate; from 3 to 15 wt. % plasticizer; from 1 to 15 wt. % secondary film former, and from 60 to 92 wt. % of at least one organic solvent. The film forming composition may further comprise a cellulose ester in addition to cellulose acetate. The cellulose ester may be present in a weight percent less than the weight percent of the cellulose acetate. The cellulose ester may be selected from the group consisting of cellulose nitrate, cellulose acetate propionate, cellulose acetate phthalate, cellulose acetate butyrate, cellulose acetate carboxylates, and combinations thereof. The tack-free dry time of the composition may be at least 10% less than the same composition comprising cellulose nitrate and the scratch-free dry time may be at least 10% less than the same composition comprising cellulose nitrate.

In another embodiment, the present invention relates to a film forming composition, comprising: cellulose acetate and at least one other cellulose ester selected from the group consisting of cellulose nitrate, cellulose acetate propionate, cellulose acetate phthalate, cellulose acetate butyrate, and cellulose acetate carboxylates, wherein the total of the cellulose acetate and the at least one other ester is from 5 to 40 wt. %, from 1 to 20 wt. % plasticizer, from 1 to 15 wt. % secondary film former, and from 50 to 92 wt. % of at least one organic solvent. In some aspects, the cellulose acetate is present in a lesser amount, based on weight, than the at least one other cellulose ester. The cellulose acetate and the at least one other cellulose ester may be present in a weight ratio from 1:99 to 50:50 cellulose acetate to at least one other cellulose ester. The tack-free drying time of the composition may be at least 10% less than the same composition comprising no cellulose acetate and the scratch-free drying time of composition may be at least 10% less than the same composition comprising no cellulose acetate. The composition may further comprise an additive. The composition may be an ink or a pharmaceutical coating.

In yet another embodiment, the present invention relates to a lacquer composition, comprising: cellulose acetate and at least one other cellulose ester selected from the group consisting of cellulose nitrate, cellulose acetate propionate, cellulose acetate phthalate, cellulose acetate butyrate, and cellulose acetate carboxylates, wherein the total of the cellulose acetate and the at least one other ester is from 5 to 40 wt. %, from 1 to 20 wt. % plasticizer, from 1 to 15 wt. % secondary film former, and from 50 to 92 wt. % of at least one organic solvent. In some aspects, the cellulose acetate is present in a lesser amount, based on weight, than the at least one other cellulose ester. The cellulose acetate and the at least one other cellulose ester may be present in a weight ratio from 1:99 to 50:50 cellulose acetate to at least one other cellulose ester. The tack-free drying time of the composition may be at least 10% less than the same composition comprising no cellulose acetate and the scratch-free drying time of composition may be at least 10% less than the same composition comprising no cellulose acetate.

In another embodiment, the present invention relates to a nail polish composition, comprising: cellulose acetate and at least one other cellulose ester selected from the group consisting of cellulose nitrate, cellulose acetate propionate, cellulose acetate phthalate, and cellulose acetate butyrate, wherein the total of the cellulose acetate and the at least one other ester is from 5 to 40 wt. %, from 1 to 20 wt. % plasticizer, from 1 to 15 wt. % secondary film former, and from 50 to 92 wt. % of at least one organic solvent. In some aspects, the cellulose acetate is present in a lesser amount, based on weight, than the at least one other cellulose ester. The cellulose acetate and the at least one other cellulose ester may be present in a weight ratio from 1:99 to 50:50 cellulose acetate to at least one other cellulose ester. The tack-free drying time of the composition may be at least 10% less than the same composition comprising no cellulose acetate and the scratch-free drying time of composition may be at least 10% less than the same composition comprising no cellulose acetate.

In yet another embodiment, the invention relates to a film forming composition, comprising: from 5 to 40 wt. % cellulose acetate, from 1 to 20 wt. % plasticizer, from 1 to 15 wt. % secondary film former, and from 50 to 92 wt. % of at least one organic solvent. The composition may comprise at least two organic solvents. The cellulose acetate may be present in an amount from 5 to 20 wt. % based on the total weight of the film forming composition. The weight ratio of plasticizer to cellulose acetate may range from 0.2:1 to 2:1 plasticizer to cellulose acetate. The composition may further comprise an additive, wherein the additive is a nitrogen-containing compound, an amine-containing compound, an amide-containing compound, or an imine-containing compound. The additive may be selected from the group consisting of phenylurea, urea, 3-aminopropyltriethoxysilane, polyethyleneimine, imidazole, aminopropyl triethyoxysilane, toluene sulfonamide, n-ethyl toluenesulfonamide, pyridines, and combinations thereof. In some aspects, the secondary film former comprises an alkyd resin. In further aspects, the secondary film former comprises toluene sulfonamide aldehyde resin. In still other aspects, the secondary film former comprises toluene sulfonamide epoxy resin. In other aspects, the secondary film former comprises an acrylic. In further aspects, the secondary film former comprises a polyester. The secondary film former may comprise at least two secondary film formers. In some aspects, the secondary film former comprises a polyvinyl resin and either an alkyd resin, an epoxy resin, or a polyester resin. The at least one organic solvent may be selected from the group consisting of an ester, a ketone, an aldehyde, an acetal, an alcohol, and combinations thereof. In some aspects, the at least one organic solvent may be selected from the group consisting of acetone, n-butyl acetate, ethyl acetate, isopropanol, ethanol, methyl ethyl ketone, diacetone alcohol, isobutanol, ethyl lactate, methyl amyl ketone, methyl propyl ketone, dimethyl carbonate, dimethyl succinate, dimethyl glutarate, dimethyl adipate, and combinations thereof. The composition may further comprise and additive, and wherein the additive is an adhesion promoter, heat stabilizer, antioxidant, acid scavenger, acrylic, dye, pigment, aroma, optical brightener, flame retardant, agricultural chemical, bioactive compound, indicator, insecticide, UV stabilizer, or a mixture thereof. The composition may further comprise a cellulose ester in addition to cellulose acetate. The cellulose ester may be present in a weight percent less than the weight percent of the cellulose acetate. The cellulose ester may be selected from the group consisting of cellulose acetate propionate, cellulose acetate butyrate, cellulose nitrate, cellulose acetate phthalate, cellulose acetate carboxylates, and combinations thereof.

In another embodiment, the present invention relates to a lacquer composition, comprising: a film forming composition comprising from 5 to 40 wt. % cellulose acetate; from 1 to 20 wt. % plasticizer; from 1 to 15 wt. % secondary film former, and from 50 to 92 wt. % of at least one organic solvent; and a diluent in an amount of from 35 to 65 wt. % based on the total weight of the lacquer composition. The film forming composition may be present from 10 to 35 wt. %, based on the total weight of the lacquer composition. The diluent may be an alcohol. In some aspects, the secondary film former comprises an alkyd resin. In further aspects, the secondary film former comprises toluene sulfonamide aldehyde resin. In still other aspects, the secondary film former comprises toluene sulfonamide epoxy resin. In other aspects, the secondary film former comprises an acrylic. In further aspects, the secondary film former comprises a polyester. In still further aspects, the secondary film former may be a polyvinyl resin. In some aspects, the secondary film former comprises at least two secondary film formers. In some aspects, the secondary film former comprises a polyvinyl resin and either an alkyd resin, an epoxy resin, or a polyester resin. The film forming composition may further comprise a cellulose ester in addition to cellulose acetate, provided that the cellulose ester is present in a weight percent less than the weight percent of the cellulose acetate. The cellulose ester may be selected from the group consisting of cellulose acetate propionate, cellulose acetate butyrate, cellulose nitrate, cellulose acetate phthalate, cellulose acetate carboxylates, and combinations thereof. In some aspects, the lacquer composition may be a nail polish further comprising a pigment. In other aspects, the lacquer composition is a wood lacquer further comprising a dye or pigment.

In yet another embodiment, the present invention relates to a nail polish composition comprising: from 5 to 40 wt. % cellulose acetate, from 1 to 20 wt. % plasticizer, from 1 to 15 wt. % secondary film former, and from 50 to 92 wt. % of at least one organic solvent. The weight ratio of plasticizer to cellulose acetate may range from 0.2:1 to 2:1 plasticizer to cellulose acetate. The weight ratio of plasticizer to secondary film former may range from 1:3 to 3:1. The composition may comprise at least two organic solvents. The composition may further comprise a diluent. The diluent may be present from 10 to 30 wt. %. The composition may further comprise an adhesion promoter. The composition may further comprise an additive, including a pigment. The tack-free dry time of the composition may be at least 10% less than the same composition comprising cellulose nitrate and the scratch-free dry time may be at least 10% less than the same composition comprising cellulose nitrate.

### DETAILED DESCRIPTION OF THE INVENTION

### I. Introduction

The present invention is directed to providing film forming compositions that use cellulose acetate as a primary film former in place of nitrocellulose, and to lacquer compositions such as wood lacquer or nail polish that contain the film forming compositions. The film forming compositions may also be used in inks, pharmaceutical coatings, packaging, and any other use in which a coating is provided as a continuous substrate on a substance. Cellulose acetate is an attractive substitute for cellulose nitrate because it is not nearly as flammable as cellulose nitrate, does not yellow over time, is less expensive than other known alternatives, including cellulose acetate butyrate and cellulose acetate propionate, and has a faster dry time in final formulations such as nail polishes and inks, over that of a comparable nitrocellulose formulations. Specifically with regard to inks and pharmaceutical coatings, the faster dry time is advantageous line speed in the production process may be maintained or increased and because the ink dries relatively faster, improved quality may be seen in terms of smearing, smudging, and adherence of the ink to the substrate (e.g., paper, coated paper, cardboard, pills, and the like). Cellulose acetate also has improved solvent resistance once applied as a film, e.g., it is more durable over time. The hardness of the film is also improved by replacing cellulose nitrate with cellulose acetate. One problem associated with cellulose acetate is the incompatibility of cellulose acetate with numerous components of known film forming and lacquer compositions. For example, cellulose acetate is incompatible with numerous solvents, plasticizers, natural resins and rosins often used as tackifiers. Additional difficulties with cellulose acetate include high viscosity and lack of adhesion to some natural, stained and/or painted substrates.

To address these problems, the present invention is directed to specific film forming compositions comprising cellulose acetate as a primary film former that can be combined with further components that are compatible with cellulose acetate to form lacquers. In some embodiments, the film forming compositions comprise cellulose acetate, a plasticizer, a secondary film former, and at least one organic solvent. Optionally, additives are also included to control opacity, viscosity, adhesion, color, and/or decorative effects of the film. Accordingly, the present invention is directed to novel film forming compositions that comprise cellulose acetate, a plasticizer, a secondary film former, and at least one organic solvent. The film forming compositions may comprise from 5 to 20 wt. % cellulose acetate, from 1 to 20 wt. % plasticizer, from 1 to 15 wt. % secondary film former, and from 50 to 92 wt. % of at least one organic solvent, based on the total weight of the film forming composition.

The present invention is also directed to lacquer compositions comprising a film forming composition and diluents (e.g., thinners). The film forming composition, as described above, may comprise from 5 to 20 wt. % cellulose acetate, from 1 to 20 wt. % plasticizer, from 1 to 15 wt. % secondary film former, and from 50 to 92 wt. % of at least one organic solvent, based on the total weight of the film forming composition. The lacquer compositions may comprise from 10 to 35 wt. % film forming composition and from 35 to 65 wt. % diluents based on the total weight of the lacquer composition.

Although the primary purpose of the present invention is to replace cellulose nitrate with cellulose acetate, it is also envisaged that blends of cellulose acetate with other cellulose esters are within the scope of this invention. Specific cellulose esters include cellulose nitrate, cellulose acetate propionate, cellulose acetate phthalate, cellulose acetate butyrate and higher cellulose acetate carboxylates including cellulose acetate octenyl succinate, cellulose acetate succinate, cellulose acetate adipate. When blending cellulose acetate with cellulose nitrate, the blend achieves a balance between the problems with cellulose nitrate, e.g., yellowing and flammability, and the drawbacks associated with cellulose acetate, e.g., compatibility limitations. A blend of cellulose acetate with cellulose acetate propionate or cellulose acetate butyrate allows for a reduction in cost as compared to cellulose acetate propionate or cellulose acetate butyrate alone, and also allows for improved compatibility as compared to cellulose acetate alone. When a blend is used, the ratio of cellulose acetate to the other cellulose ester may range from 4:1 to 1:4, e.g., from 3:1 to 1:3, or from 2:1 to 1:2. In some aspects, the cellulose ester is present in a lesser weight percentage than cellulose acetate. For example, if the film forming composition comprises 10 wt. % cellulose acetate, the cellulose nitrate, cellulose acetate phthalate, cellulose acetate propionate and/or cellulose acetate butyrate is present in an amount of less than 10 wt. %, based on the total weight of the film forming composition. In further embodiments, the cellulose acetate is used more as an additive to a cellulose nitrate, cellulose acetate phthalate, cellulose acetate propionate, cellulose acetate butyrate or other cellulose acetate carboxylate blend. In such embodiments, the cellulose acetate may be present in a lesser amount, by weight, than the other cellulose ester. For example, if the film forming composition comprises 10 wt. % cellulose acetate propionate, then the cellulose acetate is present in an amount of less than 10 wt. %, based on the total weight of the film forming composition. In some embodiments, the total weight percent of the cellulose acetate and the other cellulose ester is from 5 to 20 wt. %, based on the total weight of the film forming composition. In nail polish compositions, the total weight percent of the cellulose acetate and the other cellulose ester is from 5 to 35 wt. %, based on the total weight of the film forming composition.

### II. Film Forming Composition

The film forming compositions of the present invention comprises cellulose acetate as a primary film former, a plasticizer, a secondary film former, and at least one organic solvent. As explained herein, the specific components, their weight percentages, and their ratios to each other have resulted in film forming compositions that when incorporated into a lacquer composition, have comparable performance to the nitrocellulose film forming compositions that they are intended to replace. The film forming compositions generally have a solids content of at least 15%. In term of ranges, the solids content may range from 15 to 35% wt, e.g., 18 to 27% wt. The film forming compositions generally have a viscosity of at least 50 cPs, e.g., at least 100 cPs or at least 500 cPs, which can be measured using a Ford Cup test for up to 300 cps or using a Brookfield viscometer. In terms of ranges, the viscosity may range from 50 to 1200 cPs, e.g., from 100 to 900 cPs, or from 500 to 800 cPs.

### Cellulose Acetate

The cellulose acetate used in the film forming compositions and in the lacquer compositions as a primary film former may be prepared by known processes, including those disclosed in U.S. Pat. No. 2,740,776 and in U.S. Publication No. 2013/0096297, the entireties of which are incorporated by reference herein. Typically, acetylated cellulose is prepared by reacting cellulose with an acetylating agent in the presence of a suitable acidic catalyst.

The cellulose may be from a soft wood or from a hardwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods. In some aspects, a hardwood cellulose is preferred for acetylating.

Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high DS value, such as from 2.5 to 3, e.g., about 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C₁ to C₂₀ alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 2.9, e.g., from 1.5 to 2.9 or from 2.2 to 2.7. The degree of substitution may be selected based on the at least one organic solvent to be used in the film forming composition. For example, when acetone is used as an organic solvent, the degree of substitution may range from 2.2 to 2.65.

The number average molecular weight of the cellulose acetate may range from 15,000 to 125,000 Daltons (DA), e.g., from 40,000 to 60,000 Da and may have a polydispersity from 1 to 2.5, e.g., from 1.75 to 2.25 or from 1.8 to 2.2. All molecular weight recited herein, uncles otherwise specified, are number average molecular weights. The molecular weight may be selected based on the desired hardness of the final lacquer composition. Although greater molecular weight leads to increased hardness, greater molecular weight also increases viscosity. The cellulose acetate may be provided in powder or flake form.

In some aspects, blends of different molecular weight cellulose acetate flake or powder may be used. As described herein, cellulose acetate having greater molecular weight has greater hardness but also greater viscosity that may make the film forming compositions more difficult to use. Accordingly, a blend of high molecular weight cellulose acetate, e.g., a cellulose acetate having a molecular weight above 60,000 Da may be blended with a low molecular weight cellulose acetate, e.g., a cellulose acetate having a molecular weight below 60,000 Da. The ratio of high molecular weight cellulose acetate to low molecular weight cellulose acetate may vary depending at least on the desired hardness and viscosity but may generally range from 1:10 to 10:1; e.g., from 1:5 to 5:1 or from 1:3 to 3:1.

The cellulose acetate may be present in a film forming composition in an amount from 5 to 20 wt. % based on the total weight of the film forming composition. For example, the cellulose acetate may be present in an amount from 10 wt. % to 20 wt. %, e.g., from 11 wt. % to 15. In embodiments in which the film forming composition is to be sprayed on a substrate, the cellulose acetate may be present in the film forming composition in an amount from 5 to 10 wt. %. based on the total weight of the film forming composition. In other embodiments in which the film forming composition is to be brushed or dropped on a substrate, the cellulose acetate may be present in the film forming composition in an amount from 5 to 20 wt. % based on the total weight of the film forming composition. In some aspects, depending on the molecular weight of the cellulose acetate, the cellulose acetate may be present in the binder composition in an amount from 5 to 40 wt. % based on the total weight of the binder composition. For example, the cellulose ester may be present in an amount from 7 wt. % to 40 wt. %, e.g., from 11 wt. % to 35 wt. %, or from 9 wt. % to 35 wt. %.

### Plasticizers

The plasticizer may comprise a cellulose plasticizer generally known to one skilled in the art, including but not limited to at least one plasticizer selected from the group consisting of: Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof

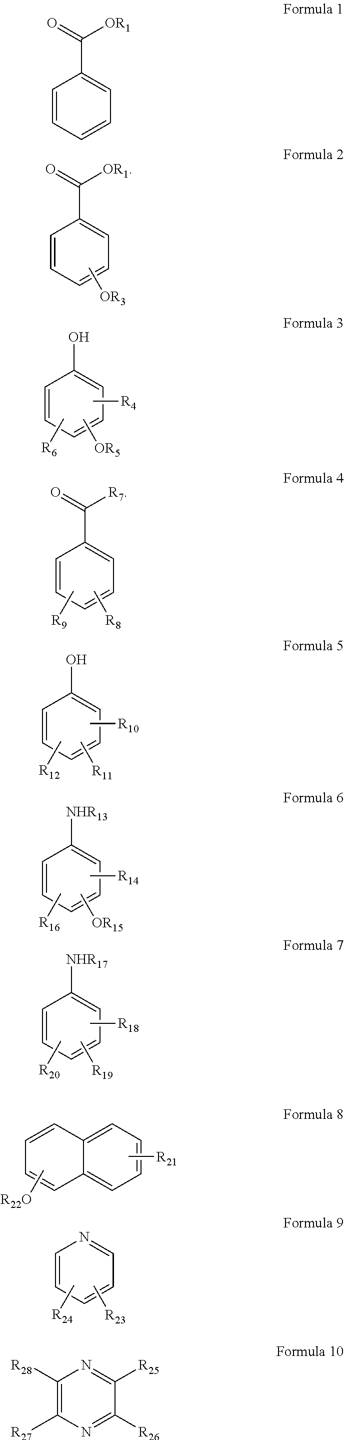

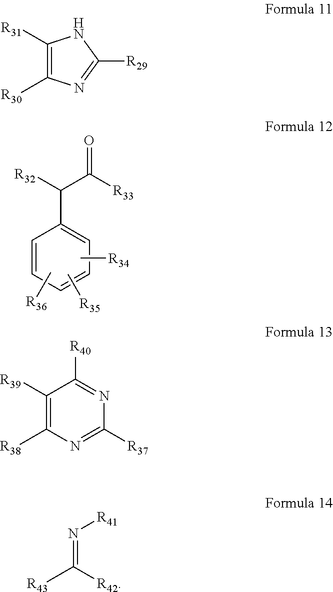

In addition to the formulas of plasticizers identified above, specific examples of plasticizer may also be selected from the group consisting of sorbitan monolaurate, N-octenyl succinic anhydride, dibutyl maleate, triethylene glycol bis (2-ethylhexanoate), n-substituted toluene sulfonamides, triacetin, diacetin, trimethyl phosphate, triethyl phosphate, tributyl phosphate, triphenyl phosphate, triethyl citrate, acetyl trimethyl citrate, acetyl triethyl citrate (ATEC), acetyl tributyl citrate, dibutyl phthalate, diaryl phthalate, diethyl phthalate, dimethyl phthalate, dimethyl ethyl phthalate, di-2-methoxyethyl phthalate, di-octyl phthalate, an di-octyl phthalate isomer, dibutyl tartrate, ethyl o-benzoylbenzoate, ethylene glycol dibenzoate, diethylene glycol dibenzoate, dipropylene glycol benzoate, glyceryl tribenzoate, trimethylolethane dibenzoate, pentaerythritol tetrabenzoate, ethyl phthalyl ethyl glycolate, methyl phthalyl ethyl glycolate, n-ethyltoluenesulfonamide, o-cresyl p-toluenesulfonate, o-toluenesulfonamide, p-toluenesulfonamide, aromatic diol, substituted aromatic diols, aromatic ethers, tripropionin, polycaprolactone, polyethylene glycol, polyethylene glycol esters, polyethylene glycol diesters, dimethyl ether of triethylene glycol, dimethyl ether tetraethylene glycol, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, a guiacol phosphate, a guiacol alkyl phosphate, C₁-C₂₀ dicarboxylic acid esters, lactones, gamma-valerolactone, dimethyl adipate, a dialkyl ester, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, an aroma, eugenol, cinnamyl alcohol, camphor, methoxy hydroxy acetophenone, Venice turpentine, Canada balsa, glycerin, glycerin esters, gum elemi, vanillin, ethylvanillin, g-valerolactone, acetyl triethylcitrate, N-methylpyrrolidinone, glycerine carbonate, 2-methoxyethanol, 1,2-dimethoxyethane, triacetin, glycerol tribenzoate, diethylphthalate, sucrose benzoate, dimethylcarbonate, diethylene glycol benzoate, dipropylene glycol benzoate, sucrose acetate isobutyrate, trimethyl phosphate, triethyl phosphate, tributyl phosphate, triphenyl phosphate, triethyl citrate, acetyl trimethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, C₁-C₂₀ diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof.

In some aspects, the plasticizer may be selected from the group consisting of propylene carbonate, g-valerolactone, acetyl triethylcitrate, N-methylpyrrolidinone, glycerine carbonate, 2-methoxyethanol, 1,2-dimethoxyethane, triacetin, glycerol tribenzoate, diethylphthalate, sucrose benzoate, dimethylcarbonate, diethylene glycol benzoate, dipropylene glycol benzoate, sucrose acetate isobutyrate, arylene sulfonamides, ethyl toluene sulfonamide, glycerin esters, citrate esters, and combinations thereof.

The plasticizer may be present in a ratio of plasticizer to cellulose acetate such that the wt. % of plasticizer in the film forming composition is 20% to 100% that of the wt. % of cellulose acetate. The plasticizer may be present in an amount from 1 to 20 wt. % based on the total weight of the film forming composition. For example, the plasticizer may be present in an amount from 2 wt. % to 7 wt. %, e.g., from 3 wt. % to 6 wt. %. In some aspects, the plasticizer may be present in a weight ratio from 0.2:1 to 2:1 plasticizer to cellulose acetate. As used herein, the term “plasticizer” refers to a component that increases the plasticity or fluidity of a material. In some aspects, a component may be introduced as an organic solvent but as the organic solvent is evaporated, it begins to function as a plasticizer. As explained herein, however, the film forming composition comprises a plasticizer and at least one organic solvent and thus even if an organic solvent begins to function as a plasticizer as it is added, the film forming composition also contains a plasticizer that functions as a plasticizer as initially added.

### Secondary Film Former

The secondary film former in the film forming composition need not form a film on its own, but must be compatible with the primary film former (e.g., cellulose acetate).

The secondary film former may be present from 1 to 15 wt. %, e.g., from 2 to 15 wt. % or from 3 to 12 wt. %, based on the total weight of the film forming composition. The amount of secondary film former used may depend on its compatibility with cellulose acetate. For example, if the secondary film former has low or limited compatibility with cellulose acetate, such as a natural resin or rosin, a lower amount of secondary film former may be used. Additionally, the molecular weight of the cellulose acetate affects the compatibility of the secondary film former with the cellulose acetate; as the number average molecular weight of the cellulose acetate decreases, compatibility increases.

In some embodiments, the secondary film former is an alkyd (typically a fatty acid plus diacid anhydride). Alkyd resins are low molecular weight polyesters formed when polyhydric alcohols react with polybasic and monobasic acids. The polyhydric alcohol or polyols may comprise a mixture of polyols having a functionality of 2 to 4. For example, ethylene glycol, diethylene glycol, propylene glycol, and neopentyl glycol are commonly used diols; glycerol and trimethylol propane are commonly used triols; and pentaerythritol is a commonly used tetraol. The polyol or combination of polyols is responsible for the branching of the alkyd. The flexibility of the resin is also influenced by the distance between the hydroxyl group groups, e.g., diethylene glycol provides a more flexible film than ethylene glycol.

The polybasic acid may comprise orthophthalic acid, which can be used in its anhydride form. Isophthalic acid may be used as a replacement for the orthophthalic acid for tougher, faster drying, heat resistant film forming compositions. Maleic anhydride may also be used as a substitute for orthophthalic acid to improve color and water resistance in film forming compositions. Longer aliphatic dibasic acids, in particular adipic and azelaic acid, may be used as minor ingredients to impart flexibility in the alkyd structure. Tri- and tetrafunctional acids or anhydrides, such as trimellitic and pyromellitic anhydride, may also be incorporated to produce alkyds of high acid value. Chlorinated and brominated compounds (e.g., tetrachloro- and tetrabromo phthalic anhydride) may be used to impart fire-retardant properties to the film forming compositions.

The monobasic fatty acid may comprise vegetable oils. Soybean oil is preferred among the vegetable oils. Linseed oil may be used for fast drying alkyds. Tall oil, safflower, and sunflower oil are also common as raw materials for drying alkyds. Coconut oil and castor oil may be used in nondrying alkyds. Palm stearin is a consumable oil that may also be used for alkyd resin production.

Alkyds are prepared by polycondensation of the acid and alcohol components, until a predetermined acid value to viscosity relationship has been achieved. Preparation may be performed by a solvent free process, by the fusion method, or by using a small amount of solvent that forms a azeotrope with water (i.e., the solvent method). Furthermore, in the preparation of alkyd resins, either the triglyceride or the fatty acid derived from it may be used as starting materials. These two procedures are referred to as the monoglyceride (alcoholysis) and the fatty acid process, respectively.

The nature and proportion of polyols, polybasic acids, and fatty acids or oils determine the properties of the alkyd resins. The amount of combinations is vast, and specification of an alkyd resin involves several parameters. A preferred way of classifying is based on the oil length and type of oil. Depending on the weight percentage of fatty acid in the resin, alkyds are referred to as short oil (<45 wt. %), medium oil (45 to 55 wt. %), or long oil (>55 wt. %). Sometimes oil length refers to the percentage of triglyceride, in which case fatty acid content should be recalculated into triglyceride. The type of fatty acid used also governs the properties of the alkyds. The alkyd resins may also be classified as drying, semidrying, and nondrying, depending on the degree of unsaturation in the fatty acid residues (Iodine number of >140, 125 to 140, and <125, respectively).

Specific examples of the alkyd resin include short oil coconut alkyds such as Duramac® 52-5205, Duramac® 52-5222, Duramac® 207-1109, Duramac® 207-1110, Duramac® 207-1205, Duramac® 207-1102, Polychem® 7137, Polychem® 7637, Polychem® 7711, Polychem® 7718, Chempol® 809-2932, Chempol® 809-2837, Chempol® 809-3351, Chempol® 809-0091, et. al.

The primary film former (e.g., cellulose acetate) may be present in a film forming composition in a ratio from 1:3 to 3:1 with the alkyd resin. For example, cellulose acetate may be present in the film forming composition in a ratio of 1.2:1.8 with the alkyd resin, e.g., 1.4:1.6 cellulose acetate to alkyd resin. The alkyd resin may be present in a film forming composition in an amount from 5 to 15 wt. % based on the total weight of the film forming composition. For example, the alkyd resin may be present in an amount from 6 wt. % to 11 wt. %, e.g., or from 7 wt. % to 9 wt. %.

In some embodiments, the secondary film former may be a polyvinyl resin that is compatible with cellulose acetate, e.g., forms a film with acceptable clarity. Examples include styrene maleic anhydride copolymer (SMA), SMA imides, ethylene maleic anhydride copolymer, styrene/acrylonitrile copolymer, styrene/allyl alcohol copolymer, polystyrene, poly(alpha-methyl styrene), styrene/butadiene copolymer, vinyl chloride/vinyl acetate/maleic acid terpolymer, vinyl chloride/vinyl acetate copolymer, vinyl chloride/vinyl acetate/vinyl alcohol terpolymer. The ratio of components in the resin may be used to adjust compatibility of the resin with cellulose acetate. For example, when the resin is SMA, the ratio of styrene to maleic anhydride may be less than 5:1, e.g., less than 3:1 or less than 2:1. The polyvinyl resin may also be used in combination with other secondary film formers to improve the compatibility of the other secondary film formers with cellulose acetate. In some aspects, the polyvinyl resin is used in combination with polyester resins, epoxy resins, and/or alkyd resins. In these aspects, the ratio of polyvinyl resin to the other secondary film former ranges from 1:4 to 4:1, e.g., from 1:3 to 3:1, from 1:2 to 2:1, or from 1.5:1 to 1:1.5

In other embodiments, the secondary film former in the film forming composition is Toluene Sulfonamide aldehyde resin (TSAR). TSARs are products obtained by reacting toluene sulfonamide or a derivative thereof with an aldehyde. TSARs are stable to light and vary from soft plastics to hard brittle resins. TSARs prepared by reacting sulfonamide with formaldehyde are most widely used as plastics. The primary film former (e.g., cellulose acetate) may be present in a film forming composition in a ratio from 1:2 to 2:1 with the TSAR. For example, cellulose acetate may be present in the film forming composition in a ratio of 1.2:1.8 with the TSAR, e.g., 1.4:1.6 cellulose acetate to TSAR. The TSAR may be present in a film forming composition in an amount from 5 to 15 wt. % based on the total weight of the film forming composition. For example, the TSAR may be present in an amount from 6 wt. % to 11 wt. %, e.g., or from 7 wt. % to 9 wt. %.

In other embodiments, the secondary film former in the film forming composition may be selected from the group consisting of toluene sulfonamide epoxy resin, acrylic, polyvinyl butyral, and a adipic acid/neopentyl glycol/trimellitic anhydride copolymer. The acrylic may be a monomer or a polymer. The primary film former (e.g., cellulose acetate) may be present in a film forming composition in a ratio from 1:3 to 3:1 with the selected secondary film former. For example, cellulose acetate may be present in the film forming composition in a ratio of 1.2:1.8 with the secondary film former, e.g., 1.4:1.6 cellulose acetate to the selected secondary film former. The selected secondary film former may be present in a film forming composition in an amount from 1 to 15 wt. % based on the total weight of the film forming composition. For example, the selected secondary film former may be present in an amount from 2 to 15 wt. %, or from 3 to 12 wt. %.

### Organic Solvent

The at least one organic solvent in the film forming composition may be an organic solvent generally known to one skilled in the art, including but not limited to aliphatic and aromatic solvents such as alcohols, ketones, esters, acetates, glycol ethers, and the like. The at least one organic solvent may be selected from the group consisting of an ester, a ketone, an aldehyde, an acetal, an alcohol, and combinations thereof. In some aspects, the solvent may be selected from the group consisting of acetone, n-butyl acetate, ethyl acetate, isopropanol, ethanol, methyl ethyl ketone, diacetone alcohol, isobutanol, ethyl lactate, methyl amyl ketone, methyl propyl ketone, dimethyl carbonate, dimethyl succinate, dimethyl glutarate, dimethyl adipate, and combinations thereof. For example, the solvent may be a combination of alcohols, acetone, and acetates, e.g., n-butyl acetate, ethyl acetate, acetone, and isopropanol. In other examples, the solvent may include acetone, dimethyl ketone, methyl ethyl ketone, n-butyl acetate, ethyl acetate, isopropanol, isobutanol, ethyl lactate, diacetone alcohol, methyl amyl ketone, methyl propyl ketone, and combinations thereof. The film forming composition may include one or more solvents as described herein in an amount of from 50 wt. % to 92 wt. %, e.g., from 65 wt. % to 85 wt. % or from 70 wt. % to 85 wt. %. When included with at least one other solvent, isopropanol may be present from 5 to 30 wt. %, e.g., from 10 to 30 wt. % or from 10 to 25 wt. %.

In some aspects, more than one organic solvent (e.g., a solvent and one or more co-solvents) is used, e.g., two organic solvents, three organic solvents, four organic solvents, five organic solvents, or more than five organic solvents. The organic solvents may be selected so that each organic solvent has a different boiling point. This combination of organic solvents selected based on boiling point may be referred to as a layered solvent system. The boiling point of the second organic solvent may be at least 5° C. greater than the boiling point of the first organic solvent, e.g., at least 10° C., or at least 15° C. The boiling point of the third solvent may then be at least 5° C. greater than the boiling point of the second organic solvent, e.g., at least 10° C., or at least 15° C. This trend may continue for as many organic solvents as are included. For example, acetone has a boiling point of 56° C., ethyl acetate has a boiling point of 77.1° C., isopropanol has a boiling point of 82.6° C., and n-butyl acetate has a boiling point of 126° C. Generally, the first organic solvent is present in the greatest amount and is the most compatible with cellulose acetate. The advantage of such a layered solvent system is that as the first organic solvent, such as acetone, is evaporated during the drying cycle, the less compatible but higher boiling point organic solvents remain for a longer duration across the drying cycle, leading to improved clarity and film forming formation in the final use of the formulation, e.g., as a lacquer. In a film forming composition comprising more than one organic solvent, the first organic solvent may be present in an amount from 50 to 90 wt. %, e.g., from 60 to 85 wt. % or from 60 to 80 wt. %; the second organic solvent may be present from 1 to 40 wt. %, e.g., from 2 to 10 wt. % or from 5 to 10 wt. %. If present, additional organic solvents may be present from 0.1 to 8 wt. %, e.g., from 0.5 to 7 wt. % or from 1 to 5 wt. %. In other aspects, so long as the total amount of organic solvents is from 50 to 92 wt. %, the ratio of first organic solvent to second organic solvent and so on may vary.

In some aspects, the film forming composition may be a LOVOC (low volatile organic compound) film forming composition, a NOVOC (no volatile organic compound) film forming composition, or may use VOC exempt organic solvents (a volatile organic compound which has been determined to have negligible photochemical activity as promulgated by the U.S. environmental Protection Agency). A volatile organic compound is generally defined as a hydrocarbon compound having a boiling point of less than 100° C. N-butyl acetate is an example of an organic solvent that is not a volatile organic compound (but still contributes to the VOC content of lacquers). Acetone and dimethyl carbonate are both examples of VOC exempt organic solvents. Isopropanol is an example of a volatile organic compound.

### Additives

In some embodiments, the film forming compositions may further comprise one or more additional additives. Such additives may be added to the film forming composition when the film forming composition is initially formed, or may be added in a downstream process, either before, during or after forming the lacquer composition. The additives may include adhesion promoters, heat stabilizers, antioxidants, acid scavengers, acrylics, dyes, pigments, aromas, optical brighteners, flame retardants, agricultural chemicals, bioactive compounds, indicators, UV stabilizers, and gloss improving agents (such as silicone fluids) and mixtures thereof. The amount of the additives may vary widely. Generally speaking, the one or more additional additives may be present in an amount ranging from 0.01 to 10 wt. %, based on the total weight of the film forming composition, e.g., from 0.05 to 8 wt. % or from 0.1 to 7.5 wt. %. Additional details for the above-mentioned components are provided below.

As discussed above, cellulose acetate generally has low compatibility with natural resins and rosins, often referred to as tackifiers. As used herein, a tackifier functions to increase the tackiness and stickiness of a composition, and is a polymer typically having a high glass transition temperature. An adhesion promoter, as used herein, is an additive included to increase the final adhesion of the composition and need not be a polymer. The adhesion promoter may also be considered a tertiary film former, with cellulose acetate being the primary film former. Adhesion promoters include, but are not limited to nitrogen-containing compounds, 5-membered nitrogen containing rings, amine-containing compounds, imine-containing compounds, amide-containing compounds, silane-containing compounds, alkoxy-containing compounds, methacrylate esters, and acrylate esters. While the amines and imines are not generally understood to be adhesion promoters, the inventors have found that in the present film forming compositions, the amines and imines do act as adhesion promoters. In some aspects, the adhesion promoter may be selected from the group consisting of phenylurea, urea, 3-aminopropyltriethoxysilane, polyethyleneimine, aminopropyl triethoxysilane, sulfonamides including toluene sulfonamide, aryl amines, cyclic amine compounds, such as pyrroles, pyrimidines, pyrazines, imidazoles, and pyrrolidines, and combinations thereof. Further examples of adhesion promoters include alkyd resins, such as toluene sulfonamide aldehyde resin (TSAR), n-ethyl o/p-toluenesulfonamide, and toluene sulfonamide resin, acrylics, imidazole and derivatives thereof, including 1-methyl imidazole. Phosphoric acid may also be used as an adhesion promoter and to improve corrosion resistance. Finally, aromatic sulfonamide may be used as an adhesion promoter. In nail polish compositions especially, sucrose acetate isobutyrate may be used as an adhesion promoter.

Without being bound by theory, it is believed that the cellulose acetate forms a continuous phase, with plasticizer and other additives dispersed therein.

The heat stabilizers may be selected from the group consisting of radical scavengers, radical terminators, metal scavengers, peroxide decomposers, and metal salts. More specifically, thermal stabilizers may include compounds selected from the group of hindered phenols, hindered amines, epoxides of natural oils, organic phosphites, and mixtures thereof. Some preferred thermal stabilizers include those sold under the names Irganox®, Irgafos®, and Irgastab® (available from Ciba). Stabilizing metal agents may be selected from the group of alkali and alkaline metal salts, including salts of lithium, sodium, potassium, rubidium, cesium, beryllium, magnesium, calcium, strontium, and barium. Suitable inorganic and organic acid salts of alkali and alkaline metals include, but are not limited to, the hydroxides, carbonates, hydrogen carbonates, citrates, lactates, tartrates, maltates, oxylates, phosphates, acetates, propionates, etc., and mixtures thereof.

Acrylics such as acrylic resins may also be considered a tertiary film former, with cellulose acetate being the primary film former. Acrylic resins are a group of related thermoplastic or thermosetting plastic substances derived from acrylic acid, methacrylic acid or other related compounds. Polymethyl acrylate is an acrylic resin that may be used in an emulsified form for a lacquer composition. Specific examples of useful (meth) acrylic polymers or resins include, but are not limited to, copolymers of methyl methacrylate with butyl acrylate, butyl methacrylate, isobutyl methacrylate, or isobornyl methacrylate (e.g., PARALOID DM-55, PARALOID B48N, PARALOID B66, ELVACITE 2550), copolymers of isobutylmethacrylate and butyl methacrylate (e.g., ELVACITE 2046), and isobutyl methacrylate polymers (e.g., PARALOID B67).

Isocyanate resins may also be included as additives. Typical isocyanate crosslinking agents and resins include hexamethylene diisocyanate (HMDI), isophorone diisocyanate (IPDI), toluene diisocynate. An exemplary isocyanate resin is sold as SASF Desmodur® HL BA.

Surface enhances may also be included as additives, generally in amounts of less than 1 wt. %. Such enhancers include siloxane compounds or polysiloxane resins, including those sold as Momentive SF69, Momentive Coatosil® FLX. Such surface enhancers remove issues associated with orange peel and improve the water resistance of the coating.

Dyes or pigments may be used to provide a desired toning or visual effect. For example, the dyes may be selected from the group consisting of C. I. Solvent Violet 13, C. I. Pigment Blue 15, C. I. Pigment Blue 28, C. I. Dispersion Violet 8, C. I. Pigment Red 122, and mixtures thereof. Examples of fluorescent dyes or optical brightener dyes include those selected from the group consisting of Eccowhite and Eccobright products (available from Eastern Color & Chemical Company), Eastobrite OB-I (available from Eastman Chemical Company), fluorescein, and mixtures thereof. Examples of specialty or novelty dyes include thermochromic and photochromic dyes. Additional dyes or pigments (as well as other additives typically included in inks, pharmaceutical coatings, and packaging) are those known in the art. Examples are disclosed in U.S. Pat. Nos. 8,586,656; 5,610,233; and 5,338,785, the entire contents and disclosures of which are hereby incorporated by reference.

With respect to nail polish specifically, the dyes for use in the present film forming compositions may include any of those dyes which are generally known for use in nail enamel compositions. These dyes may be organic or inorganic. Such dyes may include dyes that are certified by the Division of Color Technology of the United States Food and Drug Administration (FDA). Drug & Cosmetic (D&C) dyes are one category of dyes that are certified by the FDA. Examples of D&C dyes for use in the present film forming compositions may include D&C Violet No. 2, D&C Green No. 5, D&C Green No. 6, D&C Orange No. 5, D&C Red No. 17, D&C Yellow No. 8, D&C Yellow No. 10 and D&C Yellow No. 11. The dyes for use in the present film forming compositions may also be industrial dyes or metal complex dyes. Such dyes include any of the Colour Index (CI) dyes set forth by The Society of Dyers and Colourists. Examples of CI dyes for use in the present film forming compositions may include Solvent Yellow 21, Solvent Yellow 62, Solvent Yellow 82, Solvent Yellow 90, Solvent Orange 45, Solvent Orange 54, Solvent Orange 58, Solvent Orange 60, Solvent Orange 99, Solvent Red 8, Solvent Red 89, Solvent Red 91, Solvent Red 119, Solvent Red 122, Solvent Red 124, Solvent Red 127, Solvent Red 132, Solvent Red 160, Solvent Red 218, Dye Salt, Basic Blue 7, Solvent Blue 48, Solvent Blue 70, Solvent Black 27, Solvent Black 28, Solvent Black 29 and Solvent Black 34.

Examples of suitable aromas, repellant scents, odor neutralizers, and odor masks include, but are not limited to, those disclosed in Fabulous Fragrances, by Jan Moran; Fragrances of the World, by Michael Edwards; The Illustrated Encyclopedia of Essential Oils, by Julia Lawless; Chemistry of Fragrant Substances, by Paul Jose Teisseire; The Fragrance Foundation Reference Guide 1999, The Fragrances Foundation (New York, 1999), each incorporated by reference herein. Specific fragrances may be selected from the group consisting of pennyroyal, vanillin, esters, linalool, citronellal, certain aldehydes and esters, complex perfume mixtures, plant extracts, and mixtures thereof.

Examples of suitable indicators for use in the present invention include pH indicators, moisture indicators, redox indicators, and temperature indicators. Examples of suitable pH indicators include those selected from the group consisting of phenolphthalein, litmus, thymol blue, tropeolin 00, methyl yellow, methyl orange, bromophenol blue, bromocresol green, methyl red, bromothymol blue, phenol red, neutral red, thymolphthalein, alizarin yellow, tropeolin 0, nitramine, and trinitrobenzoic acid. An example of a moisture indicator is cobalt chloride. Examples of temperature indicators include thermochromic dyes, such as indoine blue, spiropyran derivatives. Examples of suitable redox indicators include those selected from the group consisting of ferroin, iodine/starch, bis(4-dialkylaminophenyl)squaraine dyes, KMnO₄, and K₂Cr₂O₇.

The UV stabilizers may be selected from the group consisting of benzotriazoles, triazines, hydroxybenzophenone, benzoxazinone, resorcinol monobenzoates, salicylic esters (e.g., 2,6-dialkylphenyl salicylate), p-octylphenyl salicylate, cinnamic derivatives, oxanilides, hydroxybenzoic esters, sterically hindered triazines, sterically hindered amine light scavengers (HALS), compounds in the Tinuvin®, Chimassorb®, Cyasorb® (available from Ciba) and Univul™ (available from BASF) product series, and mixtures thereof. UV absorbers and stabilizers are typically present at about 0.01 to about 5% by weight, based upon the total weight of the blend.

Examples of insecticides include those selected from the group consisting of organochlorine compounds, organophosphate compounds, aryl compounds, heterocyclic compounds, organosulfur compounds, carbamate compounds, formamidine compounds, dinitrophenol compounds, organotin compounds, pyrethroid compounds, acylurea compounds, botanical compounds, antibiotic compounds, fumigant compounds, repellant compounds, inorganic compounds, and mixtures thereof.

### III. Lacquer Composition

The lacquer composition of the present invention comprises a film forming composition and a diluent. The film forming composition for use in the lacquer composition is as described above. The film forming composition comprises cellulose acetate, a plasticizer, a secondary film former, and an organic solvent. The film forming composition may optionally comprise one or more additives, as described above. The diluent may be an alcohol, such as ethanol, isopropanol, and higher alcohols.

The diluent may be present in the lacquer compositions in an amount of from 35 wt. % to 65 wt. % based on the total weight of the lacquer composition. For example, the diluent may be present in an amount from 35 wt. % to 60 wt. %, e.g., from 40 wt. % to 55 wt. %, or from 45 wt. % to 50 wt. %. The amount of diluent in the lacquer composition may be adjusted such that the cellulose acetate is present in the lacquer composition in an amount from 5 wt. % to 10 wt. % based on the total weight of the lacquer composition. For example, the diluent can be included in an amount such that the cellulose acetate is present in an amount from 5.5 wt. % to 7.5 wt. % or from 6 wt. % to 7 wt. %. The amount of diluent in the lacquer composition may be adjusted such that the plasticizer is present in the lacquer composition in an amount from 0.5 wt. % to 7.5 wt. %, e.g., from 1 wt. % to 6 wt. % or from 2.5 wt. % to 5 wt. %, based on the total weight of the lacquer composition. As described above, the additives recited herein may be added to the film forming composition or may be added to the lacquer composition.

Depending on the final use of the lacquer composition, additional components may be included. For example, when the lacquer is a wood lacquer, it may be clear or it may contain pigments, dyes, or additives as described herein. Similarly, when the lacquer is a nail polish, it may be clear, pigmented, and/or may contain decorative components. Such pigments, dyes and decorative components are well known in the art.

When the lacquer is a nail polish composition, there are specific advantages seen by including cellulose acetate in the composition, whether it is the only cellulose ester, the cellulose ester present in the greatest weight percent, or even when it is the cellulose ester added as a secondary cellulose ester. One specific advantage is drying time, both in tack-free drying time and in scratch-free drying time. Commercial nail polish compositions typically include nitrocellulose as the cellulose ester. Such formulations have relatively long drying times and as a result, smearing, chipping, and other irregularities may appear on the nail if the polish is not fully dried before the wearer contacts the nail with other surfaces. Such problems also occur with other known cellulose esters used in nail polishes, such as cellulose acetate butyrate and cellulose acetate propionate. Similar benefits as those described below would also be found by substituting or adding cellulose acetate to these other cellulose esters.

By replacing the nitrocellulose with cellulose acetate, the tack-free drying time may be reduced by at least 10%, e.g., at least 20%, or at least 30%. In terms of ranges, the tack-free drying time may be reduced from 1 to 30%, e.g., from 1 to 20% or from 1 to 10%. Similarly, the scratch-free dry time may be reduced by at least 10%, e.g., at least 20%, or at least 30%. In terms of ranges, the scratch-free drying time may be reduced from 1 to 30%, e.g., from 1 to 20% or from 1 to 10%.

Even if nitrocellulose is not completely replaced by cellulose acetate, the inclusion of some cellulose acetate still has beneficial effects on the drying time. The ratio of cellulose acetate to nitrocellulose (or another cellulose ester) may range from 1:99 to 99:1, e.g., from 1:99 to 50:50, from 5:95 to 50:50 or from 5:95 to 50:50. By including cellulose acetate with nitrocellulose, the tack-free drying time of the nail polish may be reduced by at least 5%, e.g., at least 10%, at least 15%, or at least 20%. In terms of ranges, the tack-free drying time may be reduced from 1 to 40%, e.g., from 1 to 30%, from 1 to 20% or from 1 to 5%. Similarly, the scratch-free dry time may be reduced by at least 10%, e.g., at least 20%, or at least 30%. In terms of ranges, the scratch-free drying time may be reduced from 1 to 50%, e.g., from 1 to 40% or from 1 to 30%.

Such advantages with regard to drying time may also apply to inks, pharmaceutical coatings, and packaging in which the film forming composition is applied.

### IV. Methods of Using Film Forming Composition and Lacquer Composition

The present invention also includes methods of using film forming compositions and lacquer compositions. The film forming compositions may be used to coat, at least partially, a substrate. In some aspects, the substrate may be a wood substrate, e.g., untreated wood or treated wood, keratin, composite wood, and other film forming compositions. In embodiments in which the substrate is treated wood, the treated wood may be painted wood or stained wood.

The lacquer compositions may be used to provide a finish or protective cover on at least a portion of the substrate. In some aspects, the methods may comprise applying a lacquer composition as described herein by spraying, dropping, and/or brushing the lacquer composition onto an exterior or inner surface of the substrate.

The film forming composition or lacquer composition may be dried and adhered onto the substrate. The shear strength can be measured using methods known to those of skill in the art.

The present invention will be better understood in view of the following non-limiting examples.

### V. Examples

### Sample Preparation and Testing Methods

Film forming compositions and lacquer compositions were prepared for compatibility testing, which included analysis of phase separation, viscosity, stability, and clarity of each composition. The specific compositions tested are provided in the inventive examples that follow. Generally, the film forming compositions and lacquer compositions contained cellulose acetate, a plasticizer, a secondary film former, and at least one organic solvent.

For comparative purposes, film forming compositions were prepared prior to the preparation of the film forming compositions for compatibility testing. The specific compositions tested are provided in the comparative examples that follow. Generally, the film forming compositions contained cellulose acetate, a plasticizer, an alkyd resin, and at least one organic solvent.

### Comparative Examples

The sample formulations in Table 1 included cellulose acetate as a primary film former, propylene carbonate (“PrC”) as a plasticizer, acetone or dimethyl ketone (DMK) as the solvent, an alkyd resin as the secondary film former, and n-butyl-acetate as the co-solvent.

TABLE 1
Comparative Formulations

| | (A) | (B) | (C) |
|---|---|---|---|
| | Duramac ® | Polychem ® | Chempol ® |
| | 207-1205 | 7718-B- | 809-2932 |
| | (wt. %) | 75 (wt. %) | (wt. %) |
| Cellulose Acetate | 11.9% | 11.9% | 11.9% |
| Plasticizer | 3.1% | 3.1% | 3.1% |
| Solvent | 63.6% | 65% | 55% |
| Alkyd | 21.4% | 20% | 30% |

As shown in Table 1, the alkyd was varied for each formulation. Formulation A comprised Duramac® alkyd resins as the secondary film former, Formulation B comprised Polychem® alkyd resins as the secondary film former and Formulation C comprised a Chempol® alkyd resin as the secondary film former. The Duramac® 207-1205 and Polychem® 7718-B-75 are coconut short oil based alkyd resins. The Chempol® alkyd resin includes chain stopped soya. Visual inspection of the formulations revealed that all three formulations A, B, and C had significant phase separation with the cellulose acetate being in a gel form and the alkyds being in solution. Accordingly, Formulations A, B, and C would not work well to produce a non-cloudy and homogeneous film or lacquer.

### Improving Cellulose Acetate and Alkyd Compatibility:

To determine the impact of cellulose acetate and alkyd concentrations on phase separation in film forming compositions (i.e., compatibility of cellulose acetate with an alkyd), samples were prepared in which the cellulose acetate and alkyd concentrations were varied. The sample formulations included cellulose acetate as a primary film former, propylene carbonate as a plasticizer, acetone as the solvent, Duramamc® 207-1205 alkyd resin as the secondary film former, and n-butyl-acetate as the co-solvent. The sample formulations and data are shown in Table 2.

TABLE 2
Inventive Formulations

| | (A) | (B) | (C) | (D) | (E) | (F) |
|---|---|---|---|---|---|---|
| | (wt. %) | (wt. %) | (wt. %) | (wt. %) | (wt. %) | (wt. %) |
| Cellulose | 10% | 10% | 10% | 10% | 10% | 7% |
| Acetate | | | | | | |
| Plasticizer | 2.6% | 2.6% | 2.6% | 2.6% | 2.6% | 1.82% |
| Solvent | 73.11% | 75.97% | 77.40% | 83.11% | 85.97% | 81.18% |
| Duramac ® | 14.29% | 11.43% | 10.00% | 4.29% | 1.43% | 10.00% |
| 207-1205 | | | | | | |
| Solution | Phase | Stable | Stable | Stable | Stable | Stable |
| | separation | | | | | |
| Haze (%) | | 40.6 | 42.3 | 38.3 | 23.0 | 47.7 |

The formulations in Table 2 were visually inspected to determine phase separation. Reducing the concentration of cellulose acetate and alkyd can make the lacquer stable in solution state (e.g., Formulation B, containing 10 wt. % cellulose acetate and 11.43 wt. % Duramac®, was a stable translucent solution. The stable solutions were cast on clean PET film with a Bird bar applicator to obtain free standing films with 1 mil thickness. The haze of each film was measured using the HunterLab UltraScan Pro spectrophotometer with total transmission mode, respectively. The cellulose acetate lacquers with alkyd resin have a high haze percentage, even at low alkyd loading (e.g. Formulation E showed 23.0% haze with 1.43 wt. % of alkyd). Generally, film forming compositions to be incorporated into lacquer compositions such as wood lacquer or nail polish that are to be used as clear coats or glossy finishes should have a lower haze percentage than shown in Table 2. However, film forming compositions to be used in lacquers such as wood lacquer or nail polish that will have a non-glossy finish (matte) or dyes added to the film forming composition do not need to have a low haze.

Clear Coating Formulations with Cellulose Acetate and TSAR:

Toluene sulfonamide aldehyde resin (TSAR) was discovered to have good compatibility with cellulose acetate in both the solution and dry film states. To demonstrate the compatibility of cellulose acetate with a TSAR to create an effective clear coating, samples were prepared in which various components of the film forming composition were employed. The sample formulations included cellulose acetate as a primary film former with varied molecular weights, various types of plasticizers, acetone as the solvent, and TSAR (DeerLand Chemical Company, Proflex MH) as the secondary film former. The sample formulations and data are shown in Table 3. “-” indicates that a testing data was not recorded.

TABLE 3
Inventive Formulations

| | (A) | | (C) | (D) | (A) | (A) |
|---|---|---|---|---|---|---|
| | CA75k MW, | (B) | CA75k MW, | CA75k MW, | CA50k MW, | CA30k MW, |
| | Propylene | CA75k MW, | Sorbitan | Tributyl | Propylene | Propylene |
| | carbonate | Triacetin | Monolaurate | Citrate | carbonate | carbonate |
| | (wt. %) | (wt. %) | (wt. %) | (wt. %) | (wt. %) | (wt. %) |
| Cellulose | 10% | 10% | 10% | 10% | 10% | 10% |
| Acetate | | | | | | |
| Plasticizer | 2.6% | 2.6% | 2.6% | 2.6% | 2.6% | 2.6% |
| Acetone | 80.4% | 80.4% | 80.4% | 80.4% | 80.4% | 80.4% |
| TSAR | 7% | 7% | 7% | 7% | 7% | 7% |
| Viscosity¹ | 890.8 | 965.8 | 944.8 | 1089 | 602.9 | 117.0 |
| (cP) | | | | | | |
| König | 121.7 | 115.1 | — | — | — | — |
| hardness² | | | | | | |
| (sec.) | | | | | | |
| 60° Gloss³ | 93.5 | 92.9 | — | — | — | — |
| Pencil | HB/F | HB | — | — | — | — |
| Hardness⁴ | | | | | | |

¹ASTM Method D2196 (2015), “Test Methods for Rheological Properties of Non-Newtonian Materials by Rotational (Brookfield) Viscometer.”
²ASTM Method D4366-95 (1995), “Standard Test Methods for Hardness of Organic Coatings by Pendulum Damping Tests.”
³ASTM Method D523-89(1999), “Standard Test Methods for Specular Gloss.”
⁴ASTM Method D3363-05 (2005), “Standard Test Method for Film Hardness by Pencil Test.”

The viscosity in Table 3 was measured using Brookfield DV-II+ Pro viscometer with LV spindle #3. The lacquer composition having a film forming composition comprising propylene carbonate as the plasticizer and a cellulose acetate molecular weight of 75 k provided the viscosity at 890.8 cP. The formulations with other plasticizer have higher viscosity (e.g., Formulation D with tributyl citrate as the plasticizer provided viscosity of 1089 cP). The reduction of cellulose acetate molecular weight decreased the solution viscosity significantly. The lacquer compositions having a film forming composition comprising propylene carbonate as the plasticizer and approximate cellulose acetate molecular weight of 50 kDa and 30 kDa provided the viscosity at 602.9 cP and 117.0 cP, respectively. The plasticizer type affected the dry film clarity of the lacquers in Table 3. The lacquer composition having a film forming composition comprising propylene carbonate and triacetin as the plasticizer provided clear dry film, while Formulations C and D with sorbitan monolaurate and tributyl citrate as the plasticizer provided a hazy dry film.

The lacquers of Formulations A and B were cast on to aluminum Q-panel with a dry film thickness of around 2 mil for hardness tests. The pendulum rocker hardness (König) was tested with TQC Pendulum Hardness Tester SP0500 after drying for 72 hours. The gloss at 60 degrees was measured by BYK Gardner Micro-Tri-Gloss 20/60/85 degree Gloss Meter. The lacquer composition having a film forming composition comprising propylene carbonate as the plasticizer and a cellulose acetate molecular weight of 75 kDa provided better resistance to surface abrasion with a 121.7 sec. König hardness, better glossy finish with a 93.5 60° Gloss, and better resistance to surface scratching/denting with a HB/F pencil hardness.

Increase Compatibility of Cellulose Acetate with a Secondary Cellulose Ester:

To develop a cellulose acetate based nail polish, toluene sulfonamide epoxy resin (TSER) was used as secondary film former to ease the concern of formaldehyde leaching from TSAR. In order to improve the compatibility of cellulose acetate and TSAR, a small amount of highly soluble cellulose ester was employed in the nail polish sample. The sample formulations included cellulose acetate as a primary film former, propylene carbonate as plasticizer, acetone as the solvent, TSER as the secondary film former and nitrocellulose. The sample formulations are shown in Table 4.

TABLE 4
Inventive Formulations

| | (A) | (B) |
|---|---|---|
| Cellulose Acetate | 8% | 8% |
| 75k MW | | |
| Plasticizer | 2.1% | 2.1% |
| Solvent | 83.2% | 76.5% |
| TSER | 7% | 7% |
| Nitrocellulose | 0% | 4% |

Formulation B comprised 4 wt. % WALSRODER® Nitrocellulose E 560 Isopropanol 30% FF as the secondary cellulose ester. The two formulations were cast on clean PET film with a Bird bar applicator to obtain free standing films with 2 mil thickness. Visual inspection of the dry films revealed that Formulation A had phase separation and severe haze, while Formulation B was very clear and uniform film. It was concluded that highly soluble cellulose ester, such as nitrocellulose, can significantly improve the compatibility of cellulose acetate with TSER.

Clear Nail Polish Formulations with Cellulose Acetate and TSER:

Another approach to improve the compatibility of cellulose acetate and TSER is using N-ethyl toluene sulfonamide (ETS) as plasticizer. To determine the impact of ETS on dry film clarity, samples were prepared in which the level of ETS and TSER were varied. The sample formulations included cellulose acetate as a primary film former, ETS as the plasticizer, dimethyl carbonate with 1 wt. % of ethyl lactate as the solvent, and TSER as the secondary film former. The sample formulations and data are shown in Table 5.

TABLE 5
Inventive Formulations

| | (A) | (B) | (C) | (D) |
|---|---|---|---|---|
| Cellulose Acetate | 7% | 7% | 6.5% | 7% |
| ETS | 6% | 8% | 4.1% | 7% |
| Dimethyl Carbonate | 76.7% | 78.3% | 41.3% | 47.3% |
| TSER | 7% | 5% | 3.5% | 3.5% |
| Ethyl Acetate | — | — | 20% | 15% |
| Isopropanol | — | — | 20% | 15% |
| Diacetone alcohol | 1% | 1% | 3.5% | 3.5% |
| Viscosity (cP) | — | — | 502 | 794 |
| König hardness (sec.) | — | — | 100.2 | 25.2 |
| 20°/60° Gloss | — | — | 63/93 | 78/99 |
| Pencil Hardness | — | — | H | F |

The above four formulations were clear and stable in solution state. The four formulations were cast on clean PET film with Bird bar applicator to obtain free standing films with 2 mil thickness. Visual inspection of the dry films revealed that Formulation A provided a hazy film, but Formulations B, C and D afforded a very clear and uniform dry film.

Additional plasticizers were tested in combination with TSER to evaluate compatibility.

TABLE 6
Inventive Formulations

| | (E) | (F) | (G) | (H) | (I) | (J) | (K) |
|---|---|---|---|---|---|---|---|
| Cellulose Acetate | 6.75 | 6.75 | 6.75 | 6.75 | 6.75 | 6.75 | 6.75 |
| Plasticizer | ATEC | TEC | PrC | gVL | Triacetin | Diacetin | DBE6 |
| Plasticizer | 4.25 | 4.25 | 4.25 | 4.25 | 4.25 | 4.25 | 4.25 |
| (wt. %) | | | | | | | |
| TSER | 3.37 | 3.37 | 3.37 | 3.37 | 3.37 | 3.37 | 3.37 |
| Ethyl Acetate | 20 | 20 | 20 | 20 | 20 | 20 | 20 |
| Isopropanol | 20 | 20 | 20 | 20 | 20 | 20 | 20 |
| Diacetone | 4 | 4 | 4 | 4 | 4 | 4 | 4 |
| alcohol | | | | | | | |

Formulations E-K were clear and stable in solution state. When cast as films as described herein, films of Formulations E and F had the best clarity and uniformity. The film of Formulation G was hazy while the films of Formulations H-K were slightly hazy but still acceptable.

### Addition of Isopropanol to Improve Clear Nail Polish Formulations

Seven formulations were prepared as shown below to test the effect of the addition of isopropanol into a cellulose acetate solution containing solvent and plasticizer, and to test the effect of the addition of isopropanol into a cellulose acetate solution containing solvent. Each solution was cast as a film as described herein. The results are shown in Table 7. Dimethyl carbonate was used as the plasticizer.

TABLE 7
Inventive Formulations

| | (A) | (B) | (C) | (D) | (E) | (F) | (G) |
|---|---|---|---|---|---|---|---|
| Cellulose Acetate (g) | 0.5 | 0.5 | 0.5 | 0.5 | 0.6 | 0.6 | 0.6 |
| Plasticizer (g) | 2.5 | 2.5 | 2.5 | 2.5 | 0 | 0 | 0 |
| Ethyl Acetate (g) | 5 | 5 | 5 | 5.6 | 5.6 | 5.6 | 5.6 |
| Isopropanol (g) | 0 | 0.5 | 1.0 | 1.5 | 0 | 0.5 | 1.0 |

The clarity of each formulation was observed. Formulation A was translucent but when compared to Formulation B, the clarity was improved in Formulation B. Formulations C and D had even better clarity, indicating that the inclusion of isopropanol improved clarity. Similarly, Formulation E was translucent while Formulations F and G also had improved clarity, indicating that the inclusion of isopropanol improved clarity.

Two additional formulations were prepared and cast as films. The viscosity, hardness and gloss were measured. Again, dimethyl carbonate with used as the plasticizer (to the extent it remained in the film after casting) and as the solvent.

TABLE 8
Inventive Formulations

| | (H) | (I) |
|---|---|---|
| Cellulose Acetate | 6 | 6 |
| (wt. %) | | |
| Plasticizer (wt. %) | 18 | 18 |
| Ethyl Acetate (wt. %) | 38 | 56 |
| Isopropanol (wt. %) | 18 | 0 |
| Viscosity (cP) | 747.6 | 685.9 |
| Koenig Hardness (s) | 87.8 | 106.0 |
| 60° Gloss | 122 | 107 |
| 20° Gloss | 110 | 83.5 |

Visual inspection of the films indicated that Formulation H was clearer than Formulation I. Additionally, as shown in Table 8, Formulation H had improved gloss as compared to Formulation I.

### Fast-Drying Nail Polish Based on Cellulose Acetate:

One of the advantages that cellulose acetate brings to nail polish is the much faster drying time comparing to nitrocellulose based nail polish. In order to compare the drying time, three fast-drying nail polish samples were prepared with cellulose acetate and three nail polish samples were prepared with the sample formulation in which the cellulose acetate was replaced by nitrocellulose. The sample formulations included cellulose acetate or nitrocellulose as a primary film former, ETS as the plasticizer, dimethyl carbonate/acetone, ethyl acetate, isopropanol and diacetone alcohol as the solvent, and TSER as the secondary film former. The sample formulations and data are shown in Table 9.

TABLE 9
Inventive Formulations

| | (A) | (B) | (C) | (D) | (E) | (F) |
|---|---|---|---|---|---|---|
| | Cellulose | Nitro- | Cellulose | Nitro- | Cellulose | Nitro- |
| | Acetate | cellulose | Acetate | cellulose | Acetate | cellulose |
| | (wt. %) | (wt. %) | (wt. %) | (wt. %) | (wt. %) | (wt. %) |
| Cellulose | 6.75% | 6.75% | 8.0% | 8.0% | 8.0% | 8.0% |
| Ester | | | | | | |
| ETS | 4.1% | 4.1% | 5.0% | 5.0% | 5.0% | 5.0% |
| Dimethyl | 40.65% | 40.65% | 40.67% | 40.67% | 0 | 0 |
| Carbonate | | | | | | |
| Acetone | 0 | 0 | 0 | 0 | 40.67% | 40.67% |
| TSER | 3.37% | 3.37% | 4.0% | 4.0% | 4.0% | 4.0% |
| Solvents | 44% | 44% | 41% | 41% | 41% | 41% |
| Viscosity | 728.8 | 57 | 1164 | 96 | — | — |
| (cP) | | | | | | |
| Tack-free | 15 | 23-26 | 14 | 24-26 | 8 | 21 |
| (min) | | | | | | |
| Scratch- | 25 | 42-45 | 26 | 46-50 | 17 | 36 |
| free (min) | | | | | | |

The above four formulations were coated on clean glass plate with 25 mil blade applicator. The wet films were pressed with fingers until the film surface was not tacky or had no finger prints, which time was recorded as tack-free time. Then the films were scratched with a round-tip plastic stick until no scratch mark was left, which time was recorded as scratch-free time. Inspection of the dry films revealed that cellulose acetate based Formulations A and C had much shorter tack-free time and scratch-free time. Cellulose acetate was able to be used as either a primary film former or as an additive in a fast-drying nail polish. The drying-time reduction by cellulose acetate was achieved over a wide solvent tolerance as shown in Formulations A and C. Additionally, when acetone was used in place of dimethyl carbonate, the drying time was further decreased.

Reducing Drying Time of Nail Polish with Cellulose Acetate as Additive:

Cellulose acetate can be used as fast-drying additive to reduce the drying time of nitrocellulose based nail polish. In order to compare the drying time, two fast-drying nitrocellulose-based nail polish samples were prepared with various amounts of cellulose acetate. The sample formulations included nitrocellulose and cellulose acetate as primary film formers, ETS as the plasticizer, dimethyl carbonate/acetone, ethyl acetate, isopropanol and diacetone alcohol as the solvent, and TSER as the secondary film former. The sample formulations and data are shown in Table 10.

TABLE 10
Inventive Formulations

| | (A) | (B) | (C) |
|---|---|---|---|
| Cellulose | 6.75% | 6.75% | 6.75% |
| Esters | | | |
| NC:CA | 100:0 | 95:5 | 85:15 |
| ETS | 4.1% | 4.1% | 4.1% |
| Dimethyl | 40.65% | 40.65% | 40.65% |
| Carbonate | | | |
| TSER | 3.37% | 3.37% | 3.37% |
| Solvent | 44% | 44% | 44% |
| Tack-free | 26 | 18 | 17 |
| (min) | | | |
| Scratch- | 42 | 26 | 25 |
| free (min) | | | |

The above three formulations were coated on clean glass plate with 25 mil blade applicator. Inspection of the dry films revealed that a small amount of cellulose acetate was able to significantly reduce the drying time of nitrocellulose-based nail polish. As shown in Formulation B, 5 wt. % of cellulose acetate reduced the tack-free time from 26 min to 18 min and as shown in Formulation C, 15 wt. % cellulose acetate reduced the tack-free time to 17 minutes.

### Polyvinyl Resins as Secondary Film Formers

As discussed above, there are concerns with using TSAR as a secondary film former due to possible formaldehyde release over time. SMA was tested as an alternative for TSAR. In the formulations shown below, the only variable was the secondary film former. Propylene carbonate was used as the plasticizer. The formulations were cast as described herein. As shown in Table 11, replacing TSAR with SMA resulted in similar gloss at 20° and at 60° while hardness was improved.

TABLE 11
Inventive Formulations

| | Cellulose | | | Keonig | | |
|---|---|---|---|---|---|---|
| | Acetate | Plasticizer | Solvent | Hardness | | |
| | (wt. %) | (wt. %) | (wt. %) | (s) | 20° Gloss | 60° Gloss |
| Form. | 10 | 2.6 | DMK: 75.4 | 101.2 | 61.6 | 93.2 |
| (A) | | | Ethyl lactate: 5 | | | |
| Form. | 10 | 2.6 | DMK: 75.4 | 179.9 | 60.0 | 90.1 |
| (B) | | | Ethyl lactate: 5 | | | |

Polyvinyl Resins in Combination with Alkyd Secondary Film Formers

Polyvinyl resins were then investigated in combination with alkyd secondary film formers to see if they could improve the overall compatibility of cellulose acetate with alkyds. Two formulations were prepared, as described below in Table 12.

TABLE 12
Inventive Formulations

| | Cellulose | | | | Styrene:Maleic | |
|---|---|---|---|---|---|---|
| | Acetate | Plasticizer | Solvent | SMA | Anhydride | Alkyd |
| | (wt. %) | (wt. %) | (wt. %) | (wt. %) | Ratio | (wt. %) |
| Form. | 10 | ETS: 2.6 | DMK: 67.86 | 5 | 2:1 | 7.14 |
| (A) | | | Ethyl lactate: 5 | | | |
| Form. | 10 | Propylene | DMK: 71.4 | 7 | 1:1 | 4 |
| (B) | | Carbonate: | Ethyl lactate: 5 | | | |
| | | 2.6 | | | | |

The formulations were cast as films. The film of Formulation (A) was much hazier than the film of Formulation (B). This indicates that by lowering the styrene:maleic anhydride ratio, compatibility of cellulose acetate with SMA and an alkyd was improved.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A film forming composition, comprising:
from 5 to 40 wt. % cellulose acetate,
from 1 to 20 wt. % plasticizer,
from 1 to 15 wt. % secondary film former, and
from 50 to 92 wt. % of at least one organic solvent.

2. The film forming composition of claim 1, wherein the composition comprises at least two organic solvents.

3. The film forming composition of claim 1, wherein the cellulose acetate is present in an amount from 5 to 15 wt. % based on the total weight of the film forming composition.

4. The film forming composition of claim 1, wherein the weight ratio of plasticizer to cellulose acetate is from 0.2:1 to 2:1 plasticizer to cellulose acetate.

5. The film forming composition of claim 1, wherein composition further comprises an additive and wherein the additive is a nitrogen-containing compound, an amine-containing compound, an amide-containing compound, or an imine-containing compound.

6. The film forming composition of claim 1, wherein the composition further comprises an additive selected from the group consisting of: phenylurea, urea, 3-aminopropyltriethoxysilane, polyethyleneimine, imidazole, aminopropyl triethyoxysilane, toluene sulfonamide, n-ethyl toluenesulfonamide, pyridines, and combinations thereof.

7. The film forming composition of claim 1, wherein the secondary film former comprises an alkyd resin.

8. The film forming composition of claim 1, wherein the secondary film former comprises toluene sulfonamide aldehyde resin.

9. The lacquer composition of claim 1, wherein the secondary film former comprises toluene sulfonamide epoxy resin.

10. The lacquer composition of claim 1, wherein the secondary film former comprises at least two secondary film formers.

11. The lacquer composition of claim 1, wherein the secondary film former comprises a polyvinyl resin and either an alkyd resin, an epoxy resin, or a polyester resin.

12. The film forming composition of claim 1, wherein the secondary film former comprises an acrylic.

13. The film forming composition of claim 1, wherein the secondary film former comprises a polyester.

14. The film forming composition of claim 1, wherein the at least one organic solvent is selected from the group consisting of an ester, a ketone, an aldehyde, an acetal, an alcohol, and combinations thereof.

15. The film forming composition of claim 1, wherein the at least one organic solvent is selected from the group consisting of acetone, n-butyl acetate, ethyl acetate, isopropanol, ethanol, methyl ethyl ketone, diacetone alcohol, isobutanol, ethyl lactate, methyl amyl ketone, methyl propyl ketone, dimethyl carbonate, dimethyl succinate, dimethyl glutarate, dimethyl adipate, and combinations thereof.

16. The film forming composition of claim 1, wherein the composition further comprises an additive, and wherein the additive is an adhesion promoter, heat stabilizer, antioxidant, acid scavenger, acrylic, dye, pigment, aroma, optical brightener, flame retardant, agricultural chemical, bioactive compound, indicator, insecticide, UV stabilizer, or a mixture thereof

17. The film forming composition of claim 1, wherein the composition further comprises a cellulose ester in addition to cellulose acetate.

18. The film forming composition of claim 17, wherein the cellulose ester is present in a weight percent less than the weight percent of the cellulose acetate.

19. The film forming composition of claim 17, wherein the cellulose ester is selected from the group consisting of cellulose acetate propionate, cellulose acetate butyrate, cellulose nitrate, cellulose acetate phthalate, cellulose acetate carboxylates, and combinations thereof.

20. A lacquer composition, comprising:
a film forming composition comprising from 5 to 40 wt. % cellulose acetate; from 1 to 20 wt. % plasticizer; from 1 to 15 wt. % secondary film former, and from 50 to 92 wt. % of at least one organic solvent; and
a diluent in an amount of from 35 to 65 wt. % based on the total weight of the lacquer composition.
